(19) United States
(12) Patent Application Publication
(10) Pub. No.: US 2016/0267229 A1
(43) Pub. Date: Sep. 15, 2016

(54) METHOD AND SYSTEM FOR MAINTAINING PERSONAL INVENTORY OF MEDICATION

(71) Applicant: Wal-Mart Stores, Inc., Bentonville, AR (US)

(72) Inventors: Donald R. High, Noel, MO (US); Nicholas D. Rone, Bella Vista, AR (US)

(21) Appl. No.: 15/062,450

(22) Filed: Mar. 7, 2016

Related U.S. Application Data
(60) Provisional application No. 62/132,675, filed on Mar. 13, 2015.

(51) Int. Cl. G06F 19/00

(52) U.S. Cl. CPC G06F 19/326

(57) ABSTRACT

Described are a system and method of automatically maintaining a personal inventory of a medication. The method includes receiving data associated with an identification code mapped to a personal inventory of a medication for a patient, the type of the medication and an identity of the patient. An updated quantity of the personal inventory based on a quantity of the medication in the personal inventory and a quantity of dispensed or expired medication in the personal inventory is determined. The updated quantity is compared to a threshold quantity and a notification of a requirement for replenishment of the personal inventory is transmitted if the updated quantity is less than the threshold quantity. Any facility, such as a school or daycare center, that maintains one or more personal inventories of medication and has a caregiver to dispense the medication can benefit from the method.

### RELATED APPLICATIONS

This application claims priority to U.S. Provisional Application Ser. No. 62/132,675, filed on Mar. 13, 2015 entitled “METHOD AND SYSTEM FOR MAINTAINING PERSONAL INVENTORY OF MEDICATION”, the entirety of which is incorporated by reference herein.

### FIELD

The present concepts relate generally to provisioning of medication and, more specifically, to a method and system for maintaining a personal inventory of a medication.

### BACKGROUND

Modern healthcare offerings provide for the distribution of medication from a pharmacy where a prescription is filled to a location where a person can receive the prescribed medication such as a school. The medication can be administered by a caregiver such as a school nurse.

### BRIEF SUMMARY

In one aspect, a system for automatically maintaining a personal inventory of a medication includes a processor module configured to receive from a caregiver device data associated with an identification code displayed on a container containing at least a portion of a personal inventory of a medication for a patient. The processor module is further configured to receive from the caregiver device a depletion quantity of the medication and to determine an updated quantity of the personal inventory of the medication based on the depletion quantity and a quantity of the personal inventory of the medication prior to removal of the depletion quantity of the medication from the personal inventory. The processor module is also configured to compare the updated quantity and a threshold quantity. The system further includes a notification module in communication with the processor module. The notification module is configured to transmit a notification of a requirement for replenishment of the personal inventory of the medication if the comparison indicates that the updated quantity is less than the threshold quantity.

In some embodiments, the depletion quantity is a dose of the medication dispensed to the patient and in some other embodiments the depletion quantity is a quantity of the medication in the personal inventory that has surpassed an expiration date.

In some embodiments, the notification module is configured to transmit the notification to a device of at least one of the patient, a caregiver, a pharmacy and a designated medical provider.

In some embodiments, the system further comprises one or more devices having a user interface to receive an entry of the depletion quantity wherein each of the one or more devices is configured to transmit data associated with the identification code and the depletion quantity to the processor module.

In some embodiments, the caregiver device is a mobile device configured to acquire an image of the identification code.

In some embodiments, the identification code is a quick response (QR) code and in some embodiments the data associated with the identification code includes a type of medication and an identity of the patient.

In another aspect, a method of automatically maintaining a personal inventory of a medication includes receiving, at a processor module, data associated with an identification code and a quantity of a medication being dispensed to a patient. The identification code is mapped to a personal inventory of the medication for the patient, the type of the medication and an identity of the patient. The method further includes determining, at the processor module, an updated quantity of the personal inventory of the medication based on the quantity of the medication being dispensed to the patient and a quantity of the medication in the personal inventory prior to dispensing the medication to the patient. The method also includes comparing, at the processor module, the updated quantity and a threshold quantity and transmitting a notification of a requirement for replenishment of the personal inventory of the medication if the updated quantity is less than the threshold quantity.

In some embodiments, the notification is transmitted to a device of at least one of the patient, a caregiver, a pharmacy and a designated medical provider.

In some embodiments, the identification code is displayed on a container containing at least a portion of the personal inventory of the medication; and, in some embodiments, the identification code is a QR code.

In some embodiments, the threshold quantity is a value previously defined by the patient, the caregiver, the pharmacist or the designated medical provider.

In some embodiments, transmitting a notification of a requirement for replenishment includes transmitting an order to a source of medication for a defined quantity of the medication.

In another aspect, a method of automatically maintaining a personal inventory of a medication includes receiving, at a processor module, data associated with an identification code mapped to a personal inventory of a medication for a patient, the type of the medication and an identity of the patient. The method further includes determining, at the processor module, an updated quantity of the personal inventory of the medication based on a quantity of the medication in the personal inventory and a quantity of expired medication in the personal inventory. The method also includes comparing the updated quantity and a threshold quantity, and transmitting a notification of a requirement for replenishment of the personal inventory of the medication if the updated quantity is less than the threshold quantity.

In some embodiments, the notification is transmitted to a device of at least one of the patient, a caregiver, a pharmacy and a designated medical provider.

In some embodiments, the identification code is displayed on a container containing at least a portion of the personal inventory of the medication; and, in some embodiments, the identification code is a QR code.

In some embodiments, the threshold quantity is a value previously defined by the patient, the caregiver, the pharmacist or the designated medical provider.

In some embodiments, transmitting a notification of a requirement for replenishment includes transmitting an order to a source of medication for a defined quantity of the medication.

### BRIEF DESCRIPTION OF THE SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a medication administration environment in accordance with certain embodiments of a system and a method for automatically maintaining a personal inventory of a medication.

FIG. 2 is a block diagram of the caregiver device of FIG. 1 according to an embodiment.

FIG. 3 is a block diagram of a configuration of the server and database of FIG. 1 according to an embodiment.

FIG. 4A, FIG. 4B, FIG. 4C, and FIG. 4D are simplified graphical depictions showing a time sequence of a quantity of medication in a personal inventory according to one embodiment of a method of automatically maintaining a personal inventory of a medication.

FIG. 5 is a flowchart representation of an embodiment of a method of automatically maintaining a personal inventory of a medication.

### DETAILED DESCRIPTION

A person may require medication that is prescribed or recommended by a doctor or other qualified professional. In supplying the medication, many pharmacies offer online programs that include patient profile information, prescription history data, refill options, drug information, and so on. Typically, after a pharmacy fills a prescription for a customer (e.g., the doctor's patient), the patient or a person acting on behalf of the patient will obtain the prescription at the pharmacy or provide instructions for delivery of the prescription.

When prescriptions associated with various embodiments of the methods described below are first filled, a scannable identification (ID) code is mapped to information corresponding to the prescribed medication which may include a patient ID picture, patient finger print, patient and/or custodial person's communication device, emergency contact information, schedule and dosage. By way of non-limiting examples, the ID code can be a scannable barcode, a matrix barcode such as a Quick Response (QR) code, a magnetic strip code, an OCR (optical character recognition) code, an encrypted code, standard alpha-numerical characters or a code identifiable from its digital image. The ID code and some or all of the associated information can be printed on a label, bottle, container or related storage device holding the prescribed medication. The associated information can be stored in a database for subsequent electronic retrieval and display. For example, the information may be available to authorized personnel at a facility through the use of a personal electronic device such as a smartphone. After receiving authorization through a login process or other verification process, authorized personnel can identify which medications belong to which patients and when to administer the medications. A parent, guardian or other representative of a patient can be notified when the patient is to receive the medication, or has missed a prescheduled dose of medication.

Systems and methods for automatically maintaining a personal inventory of a medication are disclosed herein. In the various examples described below, the personal inventory of an individual is maintained at a particular location within a facility such as a school; however, any facility having one or more caregivers to dispense doses of medication to one or more individuals can benefit from the method. By way of examples, other facilities may include day care centers, rehabilitation centers, retirement communities, prisons, camps, nursing homes and the like where one or more medication distribution locations are available to dispense medication to individuals. In some embodiments, a facility is the residence of one or more grandparents or other relatives acting as a caregiver.

As used herein, a patient means a person using medication associated with one or more prescriptions and a caregiver means any person that dispenses medication to a patient. In some instances, a patient can self-administer the medication and therefore that patient can also be a caregiver. A prescription means an instruction provided by a medical practitioner, typically in written or printed form, that authorizes a patient to receive a particular type of medication. The prescription defines a dose, i.e., a quantity of a medicine or drug to be taken at a particular time or frequency. The word “medication” includes any drug or medicine that may be administered orally, intravenously, or by any other means of administration. A personal inventory of a medication means the total amount of a medication of a particular type held at a location within a facility for a specific patient. The personal inventory can include one or more containers of the same medication. The medication can be in any of a variety of forms such as a liquid, pill, cream, powder, suppository or nasal spray. The medication may be administered in various ways, including by example, orally, with the use of an inhaler or vaporizing humidifier, or by injection such as intravenous injection. A patient may have several prescriptions and therefore a patient may have multiple personal inventories, each corresponding to the medication prescribed in one of the prescriptions.

Schools and other facilities often face challenges based on the need to dispense the correct medication at the right time in the correct does through the correct route to the correct individual while the individual is present at the school or facility. Moreover, an individual who independently administers their own medication can be challenged with the tracking of their personal medication, especially if the individual has numerous prescriptions for different medications. The methods and systems described herein can improve the safety of a patient by reducing the occurrence of errors in maintaining an adequate inventory of a medication for the patient. Confirmation of proper maintenance of inventory levels increases the level of confidence in patients and related individuals participating in an overall program that implements the described methods. For example, a patient may be a student that requires one or more doses of medication during a school day. A caregiver, such as a school nurse or medical professional, can dispense the required doses and may be required to monitor and replenish a personal inventory of medication for each child enrolled in the program.

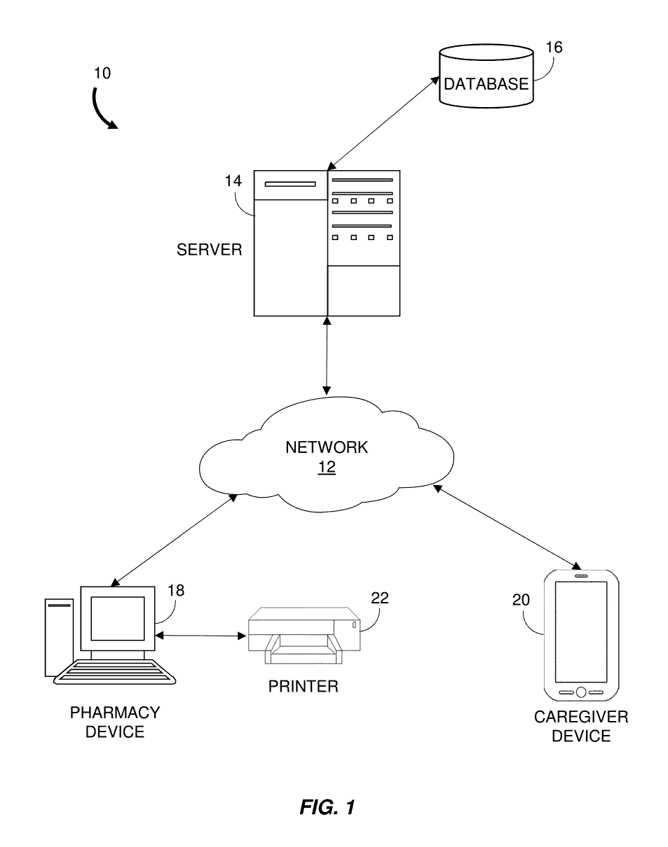

FIG. 1 is a block diagram of a medication administration environment 10 in accordance with some embodiments of a system and a method for automatically maintaining a personal inventory of a medication. The environment 10 includes a network 12 that permits the various entities sharing the environment 10 to communicate with each other. The entities include a prescription processing facility, such as a pharmacy, and a school or other facility at which a caregiver (e.g., school nurse) and patient (e.g., student) are located. The medication administration environment 10 includes system components for performing various operational steps related to maintaining the personal inventory of the medication. System components include a server 14, a database 16, a pharmacy device 18 located at the pharmacy where a prescription is filled, and a caregiver device 20 in the possession of, or accessible to, a caregiver at the facility. The database 16 may be integrated with or co-located with the server 14. Alternatively, the database 16 may be geographically remote to the server 14.

Examples of the pharmacy device 18 include a personal computer (PC), a laptop, a personal electronic device (e.g., smartphone), a workstation and the like. The pharmacy device 18 is configured to communicate with a printer 22 or other device capable of printing or forming the scannable ID code and related information, as described above, on a medication container or a label that can be attached to the medication container.

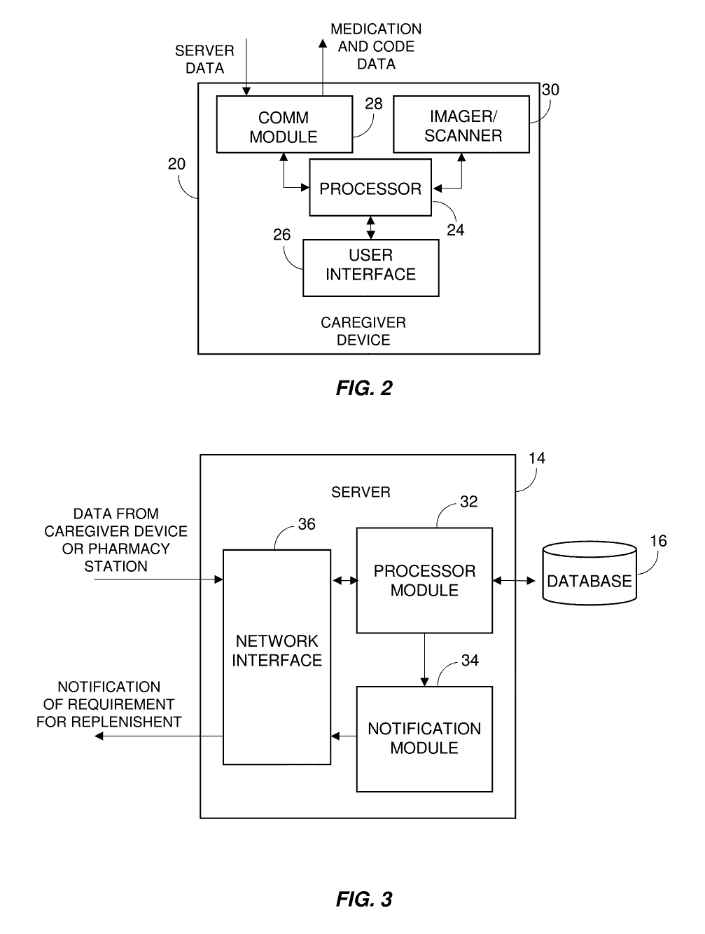

A block diagram of the caregiver device 20 is shown in FIG. 2. The device 20 includes a processor 24, user interface 26, communications module 28 and an imager or scanner 30. The communications module 28 receives data transmitted through the network 12 from the server 14 and provides the data to the processor 24. Additionally, the communications module 28 receives data from the processor 24 and transmits the data to the server 14 through the network 12. The user interface 26 provides a means for a caregiver or other user to enter data into the device 20 and to be provided data by the device 20, for example by one or more of a keyboard, display, touchscreen display, speaker and the like. Non-limiting examples of the imager/scanner 30 include a digital imager, such as a digital camera, and scanning devices capable of one-dimensional or two-dimensional scanning of the ID code. By way of non-limiting examples, the caregiver device 20 can be a smartphone or similar personal mobile device.

FIG. 3 is a block diagram of a configuration of the server 14 and database 16 of FIG. 1 according to certain embodiments. The server 14 includes a processor module 32, a notification module 34 and a network interface 36. The network interface 36 receives data transmitted from the pharmacy device 18 or the caregiver device 20 through the network 12. In addition, the network interface 36 receives data from the processor module 32 or notification module 34, and transmits the data to the pharmacy device 18 or caregiver device 20 through the network 12. The processor module 32 is configured to coordinate data read and data write functions with the database 16. The processor module 32 is further configured to provide various parameter values to the notification module 34 which, in turn, may provide notification data to the network interface 36 for transmission through the network 12 to the pharmacy device 18 and/or caregiver device 20.

Referring again to FIG. 1, the pharmacy device 18 and the caregiver device 20 communicate with the server 14 through the network 12. By way of examples, the network may be a public switched telephone network (PSTN), a mobile communications network, a data network such as the Internet, a local area network (LAN), a wide area network (WAN), or any combination of these networks or other communications networks known to those of ordinary skill. In some embodiments, other participants, such as a parent or guardian of a student, a doctor or other medical professional may have a personal electronic device, PC or laptop configured to communicate with the server 14 through the network 12.

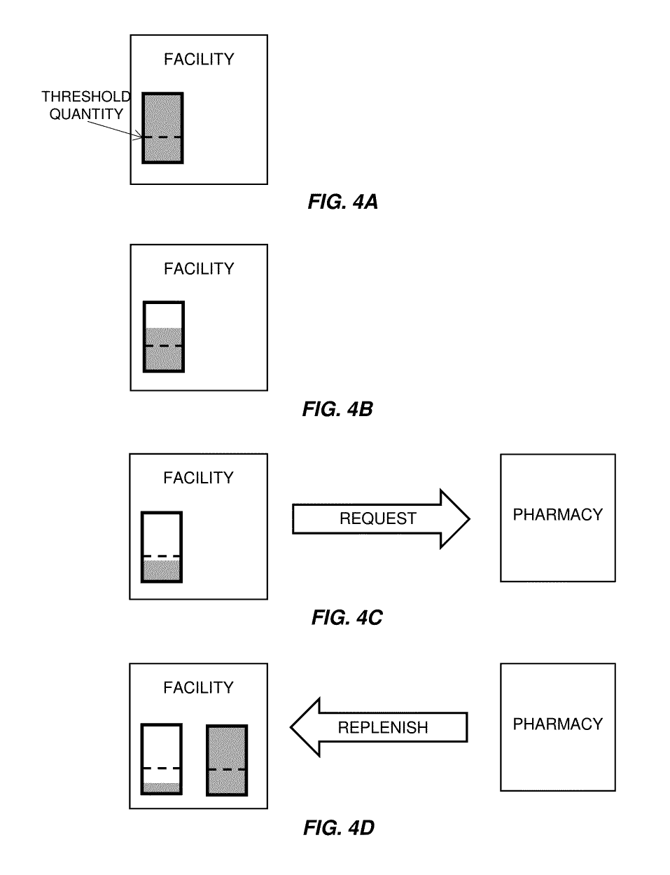

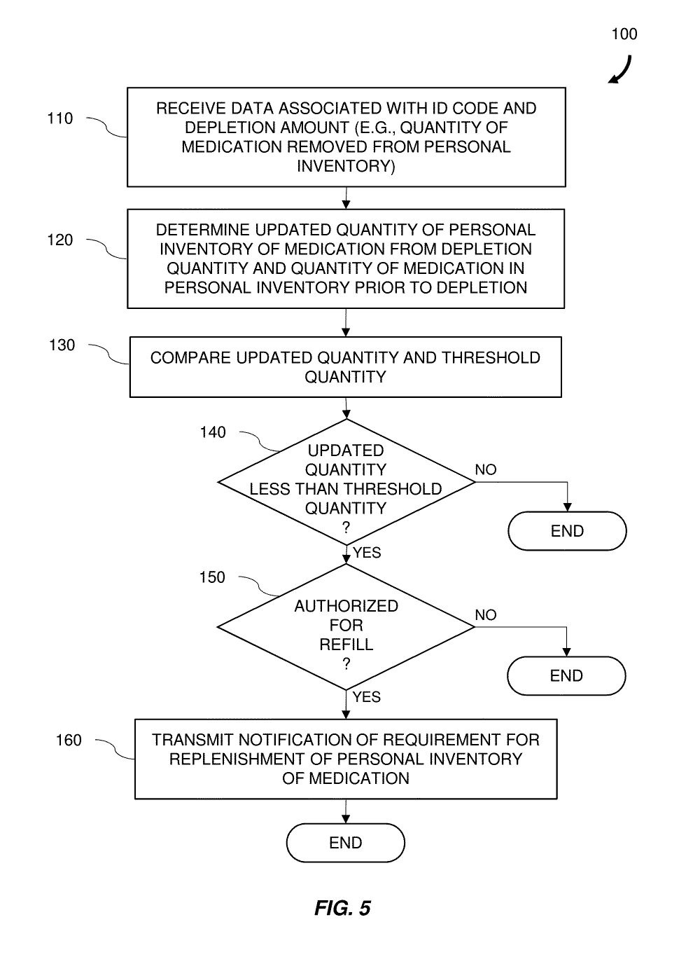

Reference is now made to FIGS. 4A to 4D which are simplified graphical depictions each showing an amount of medication held in a personal inventory of medication at one time during a time sequence. The medication is held at a facility and is available to be dispensed to a patient while at the facility. Reference is also made to FIG. 5 which shows a flowchart representation of a method 100 of automatically maintaining the personal inventory of the medication.

A threshold quantity of the medication for the purpose of defining when to replenish the personal inventory by “refilling” the prescription can be predefined by the patient, representative of the patient, doctor, pharmacist or other individual. The threshold quantity may be defined when the prescription is generated or at any later time up to and including when the medication is received at the facility. For example, the threshold quantity can be defined by the patient, parent, guardian or other representative of the patient based on a personal “tolerance level” at which the individual desires additional medication to replenish the personal inventory. The threshold quantity is compared to the amount of medication held in the personal inventory such that a replenishment of the personal inventory can automatically occur, for example, by an automatic re-order of the prescription, as described below.

Initially, the medication is delivered to the facility in any number of ways. For example, the patient may hand deliver a container of medication to the caregiver or other authorized school personnel. Alternatively, the medication can be delivered by the parent or guardian of the patient, or be mailed or sent by a delivery service to the facility. The shaded rectangular block in FIG. 4A represents a full container of a medication at the facility upon initial delivery of the medication. The container includes a number of doses to be dispensed to a patient according to the prescription. For example, if the container includes a quantity of pills, a dose may be defined as a single pill or a specified number of pills to be dispensed to the patient at one time. In another example, the container includes a known volume of liquid medication and a dose is a specified “liquid quantity,” i.e., a specified volume of liquid such as a number of milliliters or teaspoons.

When the caregiver prepares to dispense the dose of the medication to a patient, the caregiver scans the ID code on the container using the caregiver device, such as a smartphone. In response, the server may send patient specific information to the caregiver device, such as the name of the patient and an image of the patient, so that the caregiver can confirm that the patient receiving the medication is the correct patient. After confirmation of proper patient identification, the caregiver provides an indication through the user interface of the caregiver device that a dose of medication, or a specified amount of medication, has been dispensed. In response to the indication of dispensed medication, data are sent to the server to indicate that the personal inventory is being reduced by a “depletion amount” which is equal to the amount of the dose or the amount indicated by the caregiver. The data can be a numerical value indicating the number of pills dispensed or volume of liquid dispensed, and can be manually-entered through the user interface of the caregiver device. Alternatively, an indication that the prescribed dose has been dispensed can be sent to the server without the need to specifically indicate the quantity of the dispensed dose.

FIG. 4B depicts the reduced amount of medication in the personal inventory at a later time after medication has been removed from the personal inventory of the patient. According to the method 100, the server receives (step 110) data associated with the ID code and data indicating the quantity of medication depleted (i.e., “removed”) from the personal inventory. An updated quantity of medication in the patient's personal inventory is determined (step 120) based on the depletion quantity of medication and the previous quantity of medication known to be in the personal inventory. As used herein, depletion quantity means the amount of medication dispensed to the patient or otherwise removed from the personal inventory. The updated quantity is compared (step 130) to the threshold quantity. As depicted, the personal inventory includes a quantity of medication that is greater than the threshold quantity indicated by the horizontal dashed line.

After additional depletion of medication, the quantity of medication remaining in the personal inventory decreases to a value that is less than the threshold quantity as shown in FIG. 4C. As a result, it is determined (step 140) that the updated quantity is less than the threshold quantity. If it is determined that the prescription authorizes a refill (step 150), a request in the form of a notification of a requirement for replenishment of the personal inventory is sent to the device of one or more individuals or entities. In some embodiments, the notification may include or be accompanied by an order to purchase a refill amount of the medication. For example, an entity receiving the notification and the order may be a source of the medication, such as a pharmacy, that subsequently prepares a refill of the medication and ships the refill to the facility. Alternatively, a parent or guardian of the patient may receive the notification on a smartphone or similar device and respond by visiting a pharmacy to obtain the refill, and personally deliver or otherwise provide the refill to the facility. In one embodiment, both the pharmacy and the parent or guardian receive notification. In this instance, the pharmacy provides the refill and the parent or guarding is assured that an adequate inventory of medication is being maintained at the facility. Preferably, the refill replenishes the personal inventory as shown in FIG. 4D well in advance of a potential exhaustion of the amount of the medication held in the personal inventory at the facility.

The method 100 of FIG. 5 also contemplates at step 120 a depletion amount that is defined by an amount of medication in the personal inventory determined to have surpassed its expiration date. By way of non-limiting examples, expiration of an amount of medication may be determined at the server 14 from data previously associated with the ID code, data entered into the system by an authorized user, or data entered by the caregiver using the caregiver device 20 (see FIG. 1). Expiration of medication, as used herein, also includes any specific medication in the personal inventory that is no longer considered appropriate for administration. Such expired medication includes any lots or quantities of medication identified for recall by any authorized individual or entity regardless of whether or not those quantities of medication has reached their original expiration date. The identified expired medication is removed from the personal inventory and may be discarded or sent to a different location.

As will be appreciated by one skilled in the art, concepts may be embodied as a device, system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Computer program code for carrying out operations for the concepts may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Concepts are described herein with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While embodiments have been shown and described with reference to specific preferred embodiments, it should be understood by those skilled in the art that various changes in form and detail may be made therein without departing from the spirit and scope as defined by the following claims.

What is claimed is:

1. A system for automatically maintaining a personal inventory of a medication, comprising:
a processor module configured to receive from a caregiver device data associated with an identification code displayed on a container containing at least a portion of a personal inventory of a medication for a patient, the processor module further configured to receive from the caregiver device a depletion quantity of the medication and to determine an updated quantity of the personal inventory of the medication based on the depletion quantity and a quantity of the personal inventory of the medication prior to removal of the depletion quantity of the medication from the personal inventory, the processor module further configured to compare the updated quantity and a threshold quantity; and
a notification module in communication with the processor module and configured to transmit a notification of a requirement for replenishment of the personal inventory of the medication if the comparison indicates that the updated quantity is less than the threshold quantity.

2. The system of claim 1, wherein the depletion quantity is a dose of the medication dispensed to the patient.

3. The system of claim 1, wherein the depletion quantity is a quantity of the medication in the personal inventory that has surpassed an expiration date.

4. The system of claim 1, wherein the notification module is configured to transmit the notification to a device of at least one of the patient, a caregiver, a pharmacy and a designated medical provider.

5. The system of claim 1, further comprising at least one device having a user interface to receive an entry of the depletion quantity, the at least one device configured to transmit data associated with the identification code and the depletion quantity to the processor module.

6. The system of claim 1, wherein the caregiver device is a mobile device configured to acquire an image of the identification code.

7. The system of claim 1, wherein the identification code is a quick response (QR) code.

8. The system of claim 1 wherein the data associated with the identification code includes a type of medication and an identity of the patient.

9. A method of automatically maintaining a personal inventory of a medication, the method comprising:
receiving, at a processor module, data associated with an identification code and a quantity of a medication being dispensed to a patient, the identification code being mapped to a personal inventory of the medication for the patient, the type of the medication and an identity of the patient;
determining, at the processor module, an updated quantity of the personal inventory of the medication based on the quantity of the medication being dispensed to the patient and a quantity of the medication in the personal inventory prior to dispensing the medication to the patient;
comparing, at the processor module, the updated quantity and a threshold quantity; and
transmitting a notification of a requirement for replenishment of the personal inventory of the medication if the updated quantity is less than the threshold quantity.

10. The method of claim 9, wherein the notification is transmitted to a device of at least one of the patient, a caregiver, a pharmacy and a designated medical provider.

11. The method of claim 9 wherein the identification code is displayed on a container containing at least a portion of the personal inventory of the medication.

12. The method of claim 9 wherein the identification code is a quick response (QR) code.

13. The method of claim 10 wherein the threshold quantity is a value previously defined by the patient, the caregiver, the pharmacist or the designated medical provider.

14. The method of claim 9, wherein transmitting a notification of a requirement for replenishment comprises transmitting an order to a source of medication for a defined quantity of the medication.

15. A method of automatically maintaining a personal inventory of a medication, the method comprising:
receiving, at a processor module, data associated with an identification code mapped to a personal inventory of a medication for a patient, the type of the medication and an identity of the patient;
determining, at the processor module, an updated quantity of the personal inventory of the medication based on a quantity of the medication in the personal inventory and a quantity of expired medication in the personal inventory;
comparing the updated quantity and a threshold quantity; and
transmitting a notification of a requirement for replenishment of the personal inventory of the medication if the updated quantity is less than the threshold quantity.

16. The method of claim 15, wherein the notification is transmitted to a device of at least one of the patient, a caregiver, a pharmacy and a designated medical provider.

17. The method of claim 15 wherein the identification code is displayed on a container containing at least a portion of the personal inventory of the medication.

18. The method of claim 15 wherein the identification code is a quick response (QR) code.

19. The method of claim 16 wherein the threshold quantity is a value previously defined by the patient, the caregiver, the pharmacist or the designated medical provider.

20. The method of claim 15, wherein transmitting a notification of a requirement for replenishment comprises transmitting an order to a source of medication for a defined quantity of the medication.
